(19) United States
(12) Patent Application Publication
(10) Pub. No.: US 2022/0121761 A1
(43) Pub. Date: Apr. 21, 2022

(54) SYSTEM AND COMPUTER-IMPLEMENTED METHOD FOR MANAGING ACCESS TO CUSTOMER INFORMATION

(71) Applicant: STATE FARM MUTUAL AUTOMOBILE INSURANCE COMPANY, Bloomington, IL (US)

(72) Inventors: John Trent, Ojai, CA (US); Brian Edgeworth Maxwell, Edmond, OK (US); Kevin David McClelland, Normal, IL (US); William Brooks, Normal, IL (US); Lisa Ann Wargo, Normal, IL (US)

(73) Assignee: STATE FARM MUTUAL AUTOMOBILE INSURANCE COMPANY, Bloomington, IL (US)

(21) Appl. No.: 15/717,433

(22) Filed: Sep. 27, 2017

Related U.S. Application Data
(60) Provisional application No. 62/402,044, filed on Sep. 30, 2016.

(51) Int. Cl. G06F 21/62; G06F 17/30

(52) U.S. Cl. CPC G06F 21/6209; G06F 17/30867

(57) ABSTRACT

A system and computer-implemented method for better managing internal access by sales agents to electronic contact records by limiting access to records already associated with other agents. A request for access is received and a search is performed. If the record does not exist, the agent is allowed to create it. If the record exists and there is no associated agent or if the requesting agent is the associated agent, the agent is allowed to access it. If the record exists and is associated with another agent, the requesting agent is required to enter an identifying piece of information about the contact, the entered information is matched with the correct information stored in the database, and if they match, the agent is allowed to access to the record. A limit may be set on the time during which the agent is allowed to access the record before renewing the request.

### RELATED APPLICATIONS

The present U.S. non-provisional patent application is related to and claims priority benefit of a prior-filed U.S. provisional patent application having the same title, Ser. No. 62/402,044, filed Sep. 30, 2016. The entire content of the identified prior-filed application is incorporated by reference as if fully set forth herein.

### FIELD OF THE DISCLOSURE

The present disclosure generally relates to systems, methods, and computer programs for managing access to electronic contact information, and more particularly, to a system, computer-implemented method, and computer program for better managing internal access to the electronic records of clients, customers, or other contacts by employees, personnel, or other agents associated with an organization by limiting access to the records of contacts already assigned to, serviced by, or otherwise associated with specific agents.

### BACKGROUND

Organizations often maintain databases of customer or other contact information, often as part of or managed by customer information management systems (CIMSs). It is often desirable to make this customer information accessible to any agent associated with an organization having a business need to access it, and various products, such as Salesforce®, are available for facilitating and managing access. However, these products generally allow for very broad searching, and it will be appreciated that such broad access may be abused in various ways. Also, allowing customer representatives unrestricted access to all customer information without an allowed business need may create problems.

### BRIEF SUMMARY

Embodiments of the present technology provide a system, computer-implemented method, and computer program for better managing internal access to the electronic records of clients, customers, or other contacts by employees, personnel, or other sales representatives associated with an organization by limiting access to the records of contacts already assigned to, serviced by, or otherwise associated with specific sales representatives or agents.

In a first aspect, a computer-implemented method may be provided for improving the functionality of a computer for managing access to an electronic record in a database of electronic records, with each the electronic record containing a set of information about a particular contact, and may broadly comprise the following actions performed by an electronic processing element. An electronic request may be received from a requesting sales representative or agent for access to the electronic record, and the database may be searched for the electronic record. If the electronic record does exist in the database and the electronic record is associated with an agent of record who is not the requesting agent, then the requesting agent may be required to enter an identifying piece of information about the contact. The entered information may be matched with a correct identifying piece of information stored in the electronic record, and if the entered information matches the correct information, then the electronic record may be transmitted to the requesting agent. The computer-implemented method may include additional, less, or alternate actions, including those discussed elsewhere herein.

In a second aspect, a system may be provided for managing access to an electronic record in a database of electronic records, with each electronic record containing a set of information about a particular contact, and may broadly comprise the following. An electronic communications element may be configured to receive an electronic request from a requesting agent or other sales representative for access to the electronic record, and an electronic processing element may be configured to search the database of electronic records for the electronic record. If the electronic record does exist in the database and the electronic record is associated with an agent of record who is not the requesting agent, then the requesting agent may be required to enter an identifying piece of information about the contact. The entered information may be matched with a correct identifying piece of information from among the set of information stored in the electronic record, and if the entered information matches the correct information, the electronic record may be transmitted to the requesting agent. The system may include additional, less, or alternate components and/or functionality, including those discussed elsewhere herein.

Various implementations of any or all of the foregoing aspects may include any one or more of the following additional features. The identifying piece of information may be selected from the group consisting of: all or part of a Social Security Number, a telephone number, a birthdate, and an account number. If two or more electronic records in the database of electronic records match the electronic request, the requesting agent may be allowed to select the electronic record from the two or more electronic records. If the electronic record does not exist in the database, the requesting agent may be allowed to create the electronic record for the particular contact. If the electronic record does exist in the database and the particular contact is not assigned to the agent of record, the requesting agent may be allowed to access the electronic record. If the electronic record does exist in the database and the requesting agent is the agent of record, the requesting agent may be allowed to access the electronic record. If the entered identifying piece of information matches the correct identifying piece of information, a time limit may be set during which the requesting agent is allowed to access the electronic record.

Advantages of these and other embodiments will become more apparent to those skilled in the art from the following description of the exemplary embodiments which have been shown and described by way of illustration. As will be realized, the present embodiments described herein may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of the system and methods disclosed herein. It should be understood that each Figure depicts an embodiment of a particular aspect of the disclosed system and methods, and that each of the Figures is intended to accord with a possible embodiment thereof. Further, wherever possible, the following description refers to the reference numerals included in the following Figures, in which features depicted in multiple Figures are designated with consistent reference numerals. The present embodiments are not limited to the precise arrangements and instrumentalities shown in the Figures.

FIG. 1 is a depiction of an embodiment of an exemplary computer system for providing and managing access to electronic contact records;

FIG. 2 is a first flowchart of an embodiment of an exemplary computer-implemented method for managing access to the electronic records;

FIG. 3 is a second flowchart of the embodiment of the exemplary computer-implemented method for managing access to the electronic records;

FIG. 4 is a depiction of a first display in an exemplary user interface for providing and managing access to the electronic records;

FIG. 5 is a depiction of a second display in an exemplary user interface for providing and managing access to the electronic records; and

FIG. 6 is a depiction of a third display in an exemplary user interface for providing and managing access to the electronic records.

The Figures depict exemplary embodiments for purposes of illustration only. One skilled in the art will readily recognize from the following discussion that alternative embodiments of the systems and methods illustrated herein may be employed without departing from the principles of the invention described herein.

### DETAILED DESCRIPTION

The present embodiments may relate to, inter alia, systems, methods, and computer programs for managing access to electronic contact information. Broadly, embodiments allow for better managing internal access to the electronic records of clients, customers, or other contacts by employees, personnel, or other agents associated with an organization by limiting or restricting access to the records of contacts already assigned to, serviced by, or otherwise associated with specific agents or sales representatives.

As used herein, “contact” may broadly refer to substantially any client, customer, donor, or other entity or the like having a relationship with the organization. As used herein, “organization” may broadly refer to substantially any for-profit, not-for-profit, private, or public individual, group, or other entity or the like which maintains one or more databases of contact information. As used herein, “agent” may broadly refer to substantially any employee, personnel, independent contractor, or other entity or the like associated with an organization. Thus, in various non-limiting examples, the contact may be an insured person, the organization may be an insurance provider, and the agent may be an insurance agent or other sales representative; the contact may be a donor, the organization may be a not-for-profit enterprise, and the agent may be a volunteer; or the contact may be an individual, group, or legal entity, the organization may be a governmental organization, and the agent may be a governmental employee.

Some embodiments may help to protect a contact's information by adding a layer of security to a Salesforce® User Interface (UI) requiring a requesting agent, at least under some circumstances (e.g., when the requesting agent or sales representative is not the agent or sales representative associated with the contact), to enter one or more pieces of the contact's information which evidence the agent's actual relationship with the contact before a search and/or access request is allowed to proceed to the Salesforce® cloud environment. Once access is granted to such an agent, a time limit may be applied to allow the agent to temporarily service the contact's needs. Existing search tools and business rules may be leveraged to serve as a precursor or entry point into the Salesforce® cloud environment.

In some embodiments, one or more object categories may be modified to include one or more subcategories. For example, in Salesforce®, the Account Object may be modified to include several subcategories, such as Prospect (i.e., prospective contact), Contact (i.e., existing contact), and Ex-Contact (i.e., former contact), to allow for filtering and verifying search requests based on additional contact relationship definitions. One or more of these subcategories may include records of contacts which are not associated with particular agents while others of these subcategories may include records of contacts which are associated with particular agents.

Embodiments may be implemented as a standalone application, or block of code, that resides inside the Salesforce® UI in the form of a widget. The widget may contain the organization's internal search capabilities and business rules that interact with a Customer Information Management System (CIMS) before the request is sent to the Salesforce® cloud. As mentioned, the business rules could contain a time limit on access, such as twenty-four hours, to allow agents who are not the agents normally associated with certain contacts to temporarily service the needs of those contacts.

An exemplary embodiment may broadly proceed substantially as follows. A request may be received from an agent for access to a particular contact's information in an organization's contact information database. If the requested contact's information is in the database, then either (1) the contact's information is for a prospective contact with whom no agent is already associated, (2) the contact's information is for a former contact with whom no agent is currently associated, or (3) the contact's information is for an existing contact with whom an agent is already associated. If no agent is associated with the contact, then the request for the contact's information may be allowed to proceed. If an agent is associated with the contact, and the requesting agent is the associated agent, then the request may be allowed to proceed. However, if an agent is associated with the contact, and the requesting agent is not the associated agent, then the requesting agent may be required to provide information about the contact that only the contact would know and that is included in the contact's information in the database (e.g., the last four digits of the contact's SSN, the contact's phone number, the contact's account number, etc.). This both enhances security by helping to ensure that only an agent with a legitimate reason is allowed to access the contact's information and ensures that the requesting agent is in actual communication with the contact and not simply attempting to poach an otherwise unaware contact from their assigned agent. Further, it helps to ensure that an agent cannot simply open the phone book and search for names to identify individuals to pursue who are not already existing contacts. A time limit (e.g., approximately between one hour and forty-eight hours, or approximately twenty-four hours) may be set on the requesting agent's access to the contact's information in the database, after which the requesting agent may be required to make a new request for the contact's information.

In one implementation, the technology for reviewing requests for access to contact information may receive all such requests before they are sent to Salesforce®, and requests may only be allowed to continue to Salesforce® if the rules for doing so are met. In one implementation, the technology for reviewing requests for access to contact information may be largely or entirely transparent to the requesting agent, and the requesting agent may only become aware of it if the validation function is triggered.

### I. Exemplary System

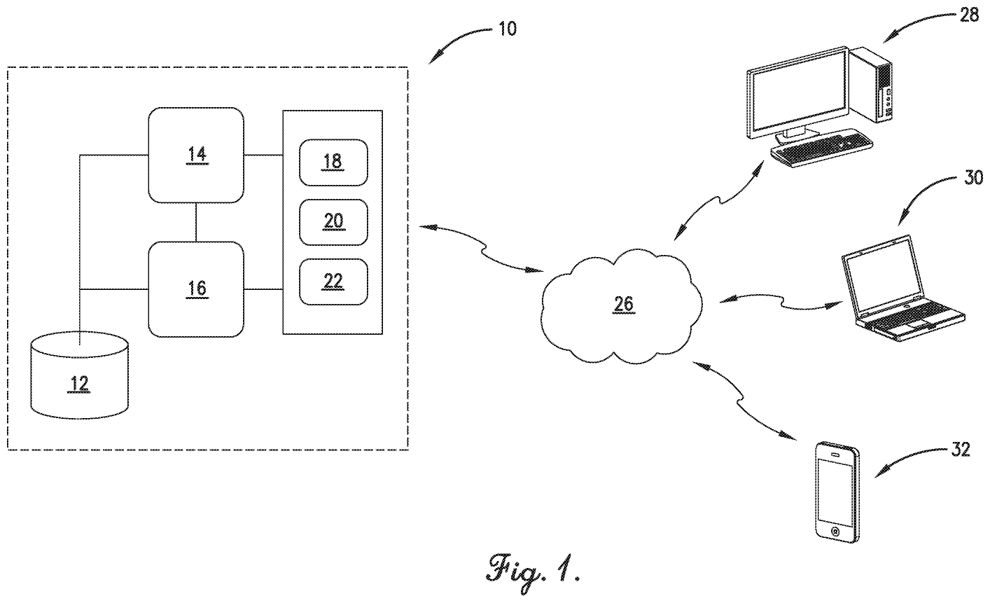

Referring to FIG. 1, an embodiment of an exemplary computer system 10 is shown for better managing internal access to the electronic records of clients, customers, or other contacts by employees, personnel, or other agents associated with an organization by limiting access to the records of contacts already assigned to, serviced by, or otherwise associated with specific agents. The exemplary system 10 may broadly comprise a database 12; a CIMS tool 14; an access management tool 16; an electronic communications element 18; an electronic memory element 20; and an electronic processing element 22. An exemplary environment in which the system 10 may operate may include an electronic communications network 26 and one or more electronic devices, such as mobile communications devices 28, portable computers 30, and/or desktop computers 32, with which agents may access the system 10 directly or via the network 26.

The database 12 may contain contact information in the form of a plurality of electronic contact records. Each contact record may or may not be assigned to or otherwise associated with a particular agent. In some embodiments, each record may be assigned to a category, and the records in some categories (e.g., Prospect, Ex-Contact) may not be associated with an agent, while the records in other categories (e.g., Contact) may be associated with an agent. The CIMS tool 14 may be substantially any suitable information management tool for managing the contact information. The access management tool 16 may be substantially any suitable access management tool, such as Salesforce®, for facilitating and managing access to the contact records.

The electronic communications element 18 may be configured to receive requests from agents for access to contact information that may be in the database 12, and to transmit the contact information found in the database 12 to the requesting agents either directly or via the electronic communications network 26. The electronic communications element 18 may include one or more transceivers (e.g., WWAN, WLAN, and/or WPAN transceivers) functioning in accordance with IEEE standards, 3GPP standards, or other standards, and be configured to receive and transmit data via the electronic communications network 26.

The electronic memory element 20 may be configured to store electronic data, including data associated with making and fulfilling requests for access to contact information. The memory element 20 may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others.

The electronic processing element 22 may be configured to execute a computer-implemented method, and embodiment of which is discussed below, for facilitating and managing access to the contact information, which may involve engaging in communication via the electronic communications element 18 and/or storing or accessing data stored in the memory element 20 in order to perform aspects or steps of the present technology, including determining whether agents requesting access to electronic contact records should or should not be allowed such access.

The electronic communications network 26 may facilitate substantially any type of data communications via any standard or technology (e.g., GSM, CDMA, TDMA, WCDMA, LTE, EDGE, OFDM, GPRS, EV-DO, UWB, WiFi, IEEE 802 including Ethernet, WiMAX, and/or others). The electronic communications network 26 may also support various local area networks (LANs), personal area networks (PAN), or short range communications protocols. The electronic devices, which may include the desktop computers 28, portable computers 30, and/or mobile communications devices 32, may be used by agents to request access to and receive electronic contact records stored in the database 16. Each such electronic device may include an electronic display configured to present a user interface to facilitate making such requests and viewing the contact information returned in response to fulfilled requests.

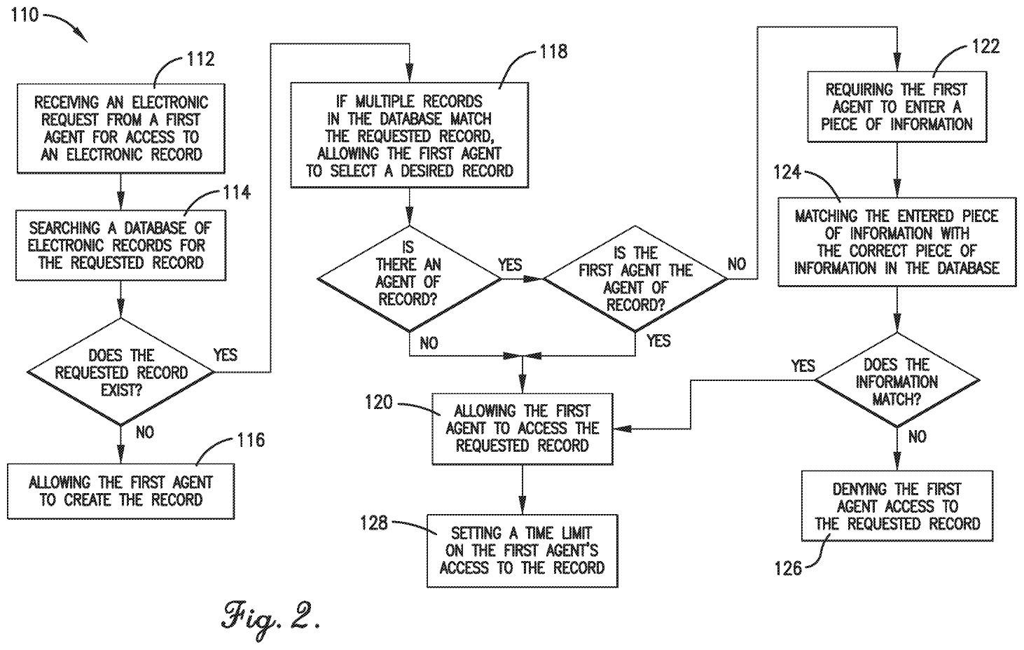

Referring also to FIG. 2, the system 10 may broadly function substantially as follows. A requesting agent may use an electronic device 28,30,32 to enter an identifier for a contact in a search box so that an electronic request may be generated and communicated to the electronic processing element 22 to search for any contact records stored in the database 12 and associated with the entered identifier, as shown in 112. The processing element 22 may use a search engine associated with the CIMS tool 14 to search the database 12 to identify the requested contact records associated with the entered identifier, and present results or at least preliminary results as follows to the requesting agent, as shown in 114.

If the CIMS search engine finds no existing contact record associated with the entered identifier, then the requesting agent may be allowed to log into the access management tool 16 and create a new record characterizing the contact associated with the entered identifier as a prospective contact or as a new contact, as shown in 116.

If the CIMS search engine finds two or more existing contact records associated with the entered identifier, then the requesting agent may be presented with certain limited information from those records and allowed to select the desired record from among the one or more returned records, as shown in 118. The one or more existing contact records in the database 12 may be assigned a type, such as Lead, Prospect, Contact, or Ex-Contact. If the requesting agent selects a record of the type Lead, Prospect, or Ex-Contact, which are not already associated with a particular agent, then the electronic request may be allowed to proceed, i.e., the requesting agent may be allowed to see the entire record, as shown in 120. If the requesting agent selects a record of the type Contact, and the record is already associated with an agent, and the requesting agent is the associated agent, then the electronic request may be allowed to proceed, as shown in 120. If the requesting agent selects a record of the type Contact, and the record is already associated with an agent, and the requesting agent is not the associated agent, then the electronic request may be blocked, and the requesting agent may be required to enter additional information about the contact that only the contact would know and that is included in the contact's record, as shown in 122. The entered information may then be matched against the same information already present in the contact record, as shown in 124, and only if the entered information matches the correct information may the electronic request be allowed to proceed, as shown in 120. If the entered information does not match the correct information, then the requesting agent may be blocked from accessing the request record, as shown in 126.

If the requesting agent is allowed to access the requested contact information, the access may be limited to a period of time (e.g., approximately between one hour and forty-eight hours, or approximately twenty-four hours) after which the requesting agent may be required to make a new request in order to continue accessing the contact information, as shown in 128.

The system 10 may include more, fewer, or alternative components and/or perform more, fewer, or alternative actions, including those discussed elsewhere herein, and particularly those discussed in the following section describing the computer-implemented method.

### II. Exemplary Computer-Implemented Method

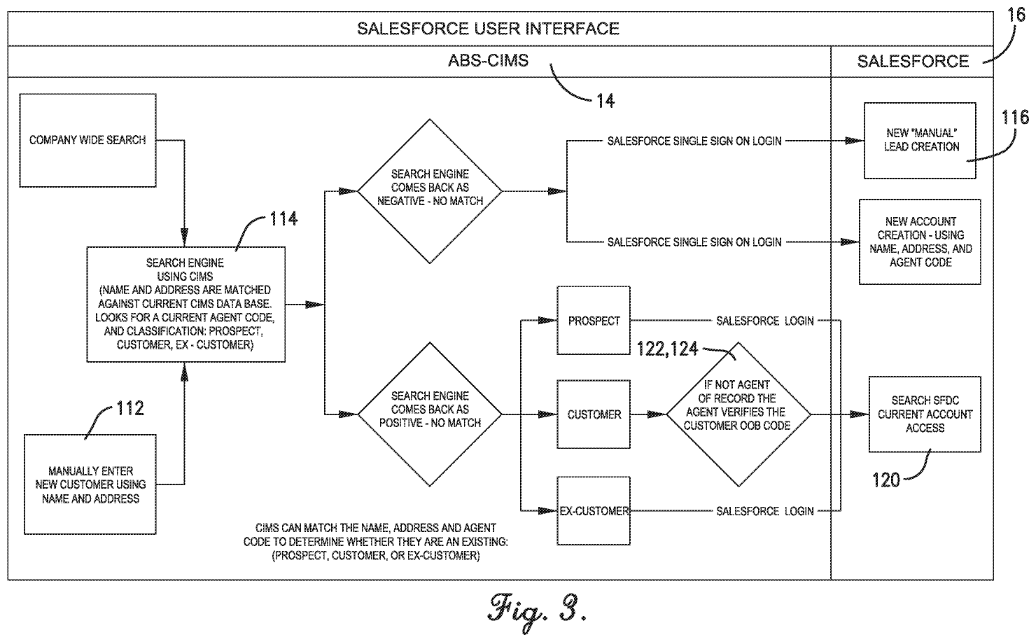

Referring to FIGS. 2 and 3, an embodiment of an exemplary computer-implemented method 110 is shown for better managing internal access to the electronic records of clients, customers, or other contacts by employees, personnel, or other agents associated with an organization by limiting access to the records of contacts already assigned to, serviced by, or otherwise associated with specific agents. The method 110 may be a corollary to the functionality of the system 10 of FIG. 1, and may be similarly implemented using the various components of the system 10 within the above-described exemplary operating environment. Broadly, the method 110 may proceed as follows.

A requesting agent may use an electronic device 28,30,32 to enter a name, address, and/or other identifier for a contact in a search box so that an electronic request may be generated and communicated to the electronic processing element 22 to use a search engine associated with the CIMS tool 14 to search for any contact records stored in the database 12 and associated with the entered identifier, as shown in 112.

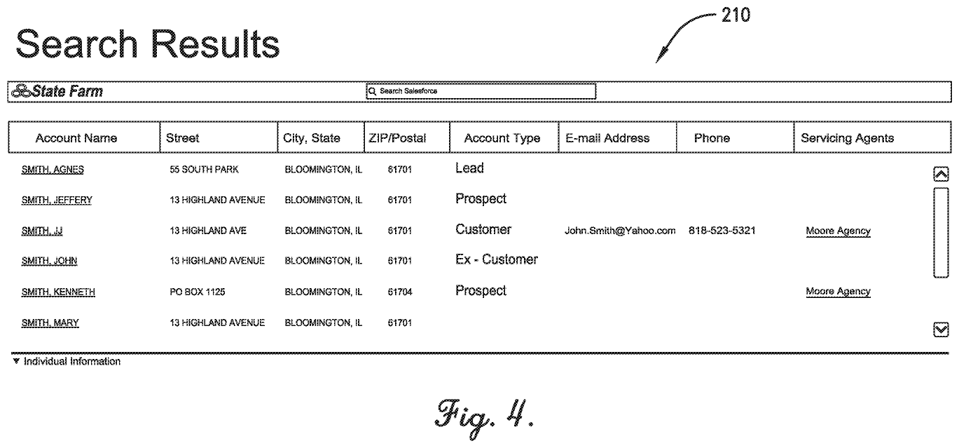

The CIMS search engine may search the database 12 to identify the requested contact records associated with the entered identifier, and present the results or at least preliminary results as follows to the requesting agent, as shown in 114. The preliminary search results may be presented as an “Enterprise View” of the records, as seen in FIG. 4, including basic contact information and the name of any associated agent.

If the CIMS search engine finds no existing contact record associated with the entered identifier, then the requesting agent may be allowed to log into the access management tool 16 and create a new record characterizing the contact associated with the entered identifier as a prospective contact or as a new contact, as shown in 116.

If the CIMS search engine finds two or more existing contact records associated with the entered identifier, as seen in FIG. 4, then the requesting agent may be presented with certain limited information 210 from those records (e.g., full name, address, account type, and/or associated agent) and allowed to select the desired record from among the one or more returned records, as shown in 118.

The one or more existing contact records in the database 12 may be assigned a type, such as Lead, Prospect, Contact, or Ex-Contact. If the requesting agent selects a record of the type Lead, Prospect, or Ex-Contact, which are not already associated with a particular agent, then the electronic request may be allowed to proceed, i.e., the requesting agent may be allowed to see the entire record, as shown in 120. If the requesting agent selects a record of the type Contact, and the record is already associated with an agent, and the requesting agent is the associated agent, then the electronic request may be allowed to proceed, as shown in 120.

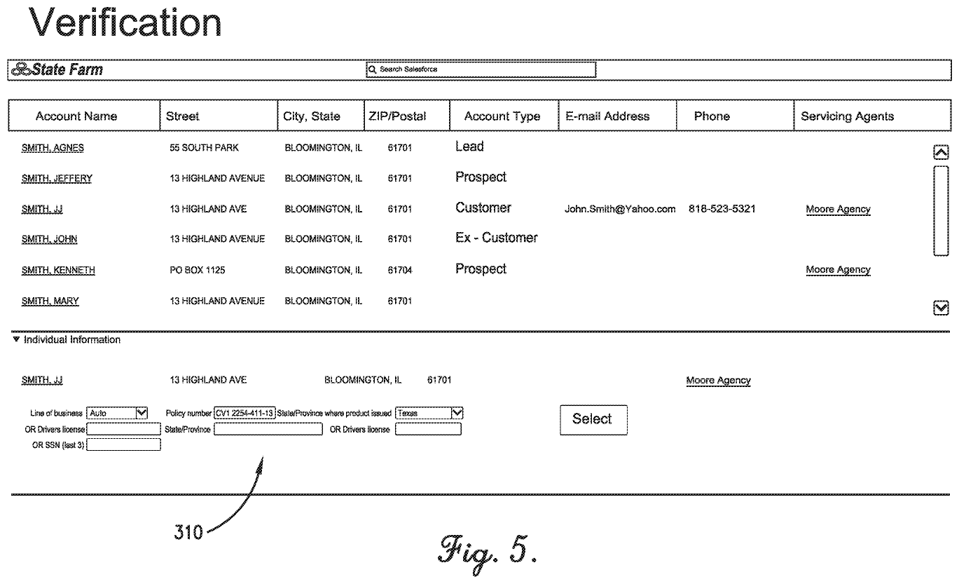

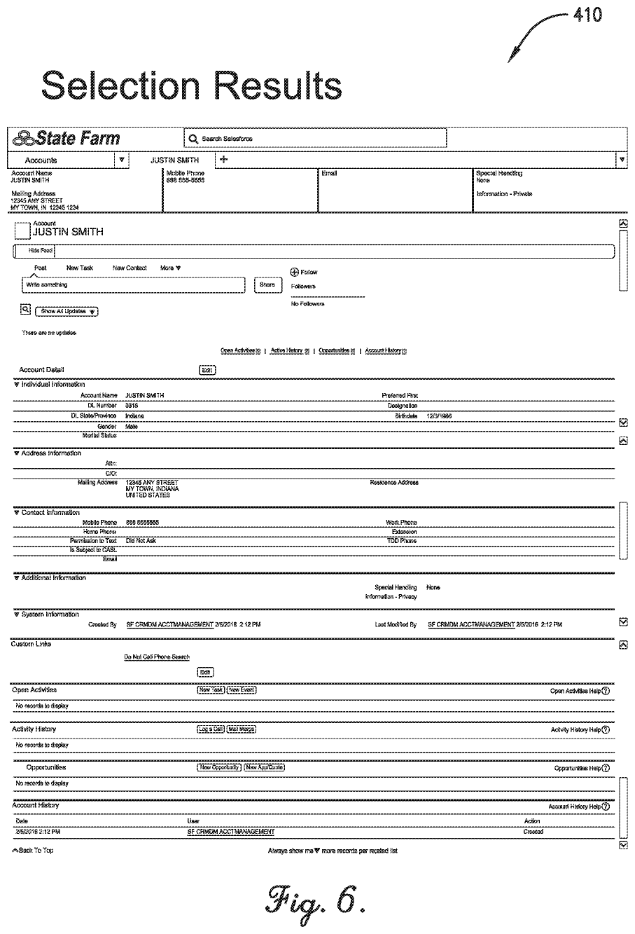

However, if the requesting agent selects a record of the type Contact, and the record is already associated with an agent, and the requesting agent is not the associated agent, then the electronic request may be blocked, and the requesting agent may, as seen in FIG. 5, be required to enter additional information 310 about the contact that only the contact would know and that is included in the contact's record (e.g., the last four digits of the contact's Social Security Number (SSN), the contact's phone number, the contact's account number, etc.), as shown in 122. The entered information may then be matched against the same information already present in the contact record, as shown in 124, and only if the entered information matches the correct information may the electronic request be allowed to proceed, as shown in 120. If the request is allowed to proceed, then the agent may, as seen in FIG. 6, be allowed to view the requested electronic record 410. If the entered information does not match the correct information, then the requesting agent may be blocked from accessing the request record, as shown in 126.

If the requesting agent is allowed to access the requested contact information, the access may be limited to a period of time (e.g., approximately between one hour and forty-eight hours, or approximately twenty-four hours) after which the requesting agent may be required to make a new request in order to continue accessing the contact information, as shown in 128.

In one embodiment, the initial request to find and access a particular contact record occurs outside of Salesforce®, and only if the requesting agent satisfies the established rules for accessing the requested record is the request allowed to proceed to Salesforce® and the requesting agent allowed to view the entire record. The computer-implemented method 110 may perform more, fewer, or alternative actions, including those discussed elsewhere herein.

### III. Exemplary Computer-Readable Medium

Referring again to FIG. 2, an embodiment of a non-transitory computer-readable medium with an exemplary executable computer program stored thereon is shown for better managing internal access to the electronic records of clients, customers, or other contacts by employees, personnel, or other agents associated with an organization by limiting access to the records of contacts already assigned to, serviced by, or otherwise associated with specific agents. The non-transitory computer-readable medium with the executable computer program stored thereon may make use of the various components of the system 10 within the above-described exemplary operating environment, and the executable program may broadly instruct certain components of the system 10 to perform the method 110 as follows.

A requesting agent may use an electronic device 28,30,32 to enter an identifier for a contact in a search box so that an electronic request may be generated and communicated to the electronic processing element 22 to search for any contact records stored in the database 12 and associated with the entered identifier, as shown in 112. The processing element 22 may use a search engine associated with the CIMS tool 14 to search the database 12 to identify the requested contact records associated with the entered identifier, and present the results or at least preliminary results as follows to the requesting agent, as shown in 114.

If the CIMS search engine finds no existing contact record associated with the entered identifier, then the requesting agent may be allowed to log into the access management tool 16 and create a new record characterizing the contact associated with the entered identifier as a prospective contact or as a new contact, as shown in 116.

If the CIMS search engine finds two or more existing contact records associated with the entered identifier, then the requesting agent may be presented with certain limited information from those records and allowed to select the desired record from among the one or more returned records, as shown in 118. The one or more existing contact records in the database 12 may be assigned a type, such as Lead, Prospect, Contact, or Ex-Contact. If the requesting agent selects a record of the type Lead, Prospect, or Ex-Contact, which are not already associated with a particular agent, then the electronic request may be allowed to proceed, i.e., the requesting agent may be allowed to see the entire record, as shown in 120. If the requesting agent selects a record of the type Customer, and the record is already associated with an agent, and the requesting agent is the associated agent, then the electronic request may be allowed to proceed, as shown in 120.

If the requesting agent selects a record of the type Customer, and the record is already associated with an agent, and the requesting agent is not the associated agent, then the electronic request may be blocked, and the requesting agent may be required to enter additional information about the contact that only the contact would know and that is included in the contact's record, as shown in 122. The entered information may then be matched against the same information already present in the contact record, as shown in 124, and only if the entered information matches the correct information may the electronic request be allowed to proceed, as shown in 120. If the entered information does not match the correct information, then the requesting agent may be blocked from accessing the request record, as shown in 126.

If the requesting agent is allowed to access the requested contact information, the access may be limited to a period of time (e.g., approximately between one hour and forty-eight hours, or approximately twenty-four hours) after which the requesting agent may be required to make a new request in order to continue accessing the contact information, as shown in 128.

The executable program stored on the non-transitory computer-readable medium may instruct the system to perform more, fewer, or alternative actions, including those discussed elsewhere herein, and particularly those discussed in the preceding section describing the computer-implemented method.

### V. Additional Considerations

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in exemplary configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (e.g., code embodied on a non-transitory, machine-readable medium) or hardware. In hardware, the routines, etc., are tangible units capable of performing certain operations and may be configured or arranged in a certain manner. In exemplary embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules may provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and may operate on a resource (e.g., a collection of information).

The various operations of exemplary methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some exemplary embodiments, comprise processor-implemented modules.

Similarly, the methods or routines described herein may be at least partially processor implemented. For example, at least some of the operations of a method may be performed by one or more processors or processor-implemented hardware modules. The performance of certain operations may be distributed among the one or more processors, not only residing within a single machine, but deployed across a number of machines. In some exemplary embodiments, the processor or processors may be located in a single location (e.g., within a home environment, an office environment or as a server farm), while in other embodiments the processors may be distributed across a number of locations.

The performance of certain operations may be distributed among the one or more processors, not only residing within a single machine, but deployed across a number of machines. In some exemplary embodiments, the one or more processors or processor implemented modules may be located in a single geographic location (e.g., within a home environment, an office environment, or a server farm). In other exemplary embodiments, the one or more processors or processor-implemented modules may be distributed across a number of geographic locations.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based upon any statement made in any section of this patent (other than the language of the claims). To the extent that any term recited in the claims at the end of this disclosure is referred to in this disclosure in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based upon the application of 35 U. S.C. § 112, sixth paragraph.

The term “insurance policy,” as used herein, generally refers to a contract between an insurer and an insured. In exchange for payments from the insured, the insurer pays for damages to the insured which are caused by covered perils, acts or events as specified by the language of the insurance policy. The payments from the insured are generally referred to as “premiums,” and typically are paid on behalf of the insured upon purchase of the insurance policy or over time at periodic intervals. The amount of the damages payment is generally referred to as a “coverage amount” or a “face amount” of the insurance policy. An insurance policy may remain (or have a status or state of) “in-force” while premium payments are made during the term or length of coverage of the policy as indicated in the policy. An insurance policy may “lapse” (or have a status or state of “lapsed”), for example, when the parameters of the insurance policy have expired, when premium payments are not being paid, when a cash value of a policy falls below an amount specified in the policy (e.g., for variable life or universal life insurance policies), or if the insured or the insurer cancels the policy.

The terms “insurer,” “insuring party,” and “insurance provider” are used interchangeably herein to generally refer to a party or entity (e.g., a business or other organizational entity) that provides insurance products, e.g., by offering and issuing insurance policies. Typically, but not necessarily, an insurance provider may be an insurance company.

Although the embodiments discussed herein relate to property insurance policies, it should be appreciated that an insurance provider may offer or provide one or more different types of insurance policies. Other types of insurance policies may include, for example, homeowners insurance; condominium owner insurance; renter's insurance; life insurance (e.g., whole-life, universal, variable, term); health insurance; disability insurance; long-term care insurance; annuities; business insurance (e.g., property, liability, commercial auto, workers compensation, professional and specialty liability, inland marine and mobile property, surety and fidelity bonds); boat insurance; insurance for catastrophic events such as flood, fire, volcano damage and the like; motorcycle insurance; farm and ranch insurance; pert insurance, personal article insurance; personal liability insurance; personal umbrella insurance; community organization insurance (e.g., for associations, religious organizations, cooperatives); and other types of insurance products. In embodiments as described herein, the insurance providers process claims related to insurance policies that cover one or more properties (e.g., homes, automobiles, personal articles), although processing other insurance policies is also envisioned.

The terms “insured,” “insured party,” “policyholder,” “customer,” “claimant,” and “potential claimant” may be used interchangeably herein to refer to a person, party, or entity (e.g., a business or other organizational entity) that is covered by the insurance policy, e.g., whose insured article or entity (e.g., property, life, health, auto, home, business) is covered by the policy.

Typically, a person or customer (or an agent of the person or customer) of an insurance provider fills out an application for an insurance policy. In some cases, the data for an application may be automatically determined or already associated with a potential customer. The application may undergo underwriting to assess the eligibility of the party and/or desired insured article or entity to be covered by the insurance policy, and, in some cases, to determine any specific terms or conditions that are to be associated with the insurance policy, e.g., amount of the premium, riders or exclusions, waivers, and the like. Upon approval by underwriting, acceptance of the applicant to the terms or conditions, and payment of the initial premium, the insurance policy may be in-force, (i.e., the policyholder is enrolled).

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still cooperate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

This detailed description is to be construed as examples and does not describe every possible embodiment, as describing every possible embodiment would be impractical, if not impossible. One could implement numerous alternate embodiments, using either current technology or technology developed after the filing date of this application.

1. A computer-implemented method for improving the functioning of a computer for managing access to an electronic record in a database of electronic records, the electronic record containing a set of information about a particular contact, the computer-implemented method comprising the following performed by an electronic communications element and a plurality of electronic processing elements distributed across a number of geographic locations and electrically connected via a server network:
receiving, by the electronic communications element from a user interface of an electronic device via the server network, an electronic request from a requesting user who is different from the contact for access to the electronic record;
searching, by the at least one of the plurality of electronic processing elements using an electronic search engine based upon an identifier in the electronic request, the database for the electronic record, the database located remotely from the electronic device in the server network; and
responsive to determining that the electronic record is assigned a type having assigned a user of record and the requesting user is different from the user of record,
requiring, by the by the at least one of the plurality of electronic processing elements via the user interface of the electronic device, the requesting user to enter an identifying piece of information about the contact,
matching, by the at least one of the plurality of electronic processing elements, the entered identifying piece of information with a correct identifying piece of information from among the set of information stored in the electronic record, and
responsive to determining that the entered identifying piece of information matches the correct identifying piece of information, transmitting, using the electronic communications element to the user interface of the electronic device, the electronic record via a limited-time access by setting, by the at least one of the plurality of electronic processing elements, a time limit during which the electronic device is allowed access to the electronic record in the server network,
wherein the at least one of the plurality of electronic processing elements automatically eliminates the time limit based upon determining that the electronic record is assigned a type that has no user of record assigned thereto or the requesting user is the same as the user of record.

2. The computer-implemented method as set forth in claim 1, wherein the identifying piece of information is selected from the group consisting of: all or part of a Social Security Number, a telephone number, a birthdate, and an account number.

3. (canceled)

4. The computer-implemented method as set forth in claim 1, further including: responsive to determining that the electronic record does not exist in the database, allowing the requesting user to create the electronic record for the particular contact.

5. The computer-implemented method as set forth in claim 1, further including: responsive to determining that the electronic record does exist in the database and the particular contact is not assigned to the user of record, allowing the requesting user to access the electronic record.

6. The computer-implemented method as set forth in claim 1, further including: responsive to determining that the electronic record does exist in the database and the requesting user is the user of record, allowing the requesting user to access the electronic record.

7. (canceled)

8. The computer-implemented method as set forth in claim 1, wherein the computer-implemented method is embodied in a computer program stored on a non-transitory computer readable storage medium and executed by the electronic processing element of the computer.

9.-13. (canceled)

14. A system for managing access to an electronic record in a database of electronic records, the electronic record containing a set of information about a particular contact, the system comprising:
an electronic communications element configured to receive an electronic request from a requesting user via a server network from a user interface of an electronic device for access to the electronic record; and
a plurality of electronic processing elements configured to;
search the database of electronic records located remotely from the electronic device in the server network for the electronic record with an electronic search engine based upon an identifier in the electronic request; and
responsive to determining that the electronic record is assigned a type having assigned a user of record and the requesting user is different from the user of record:
require via the user interface of the electronic device the requesting user to enter an identifying piece of information about the contact,
match the entered identifying piece of information with a correct identifying piece of information from among the set of information stored in the electronic record, and
responsive to determining that the entered identifying piece of information matches the correct identifying piece of information, transmit the electronic record to the user interface of the electronic device using the electronic communications element via a limited-time access by setting a time limit during which the electronic device is allowed access to the electronic record in the server network,
wherein the plurality of electronic processing elements automatically eliminates the time limit based upon determining that the electronic record is assigned a type that has no user of record assigned thereto or the requesting user is the same as the user of record, and
wherein the electronic communications element and the plurality of electronic processing elements are distributed across a number of geographic locations and electrically connected via a server network.

15. The system as set forth in claim 14, wherein the identifying piece of information is selected from the group consisting of: all or part of a Social Security Number, a telephone number, a birthdate, and an account number.

16. (canceled)

17. The system as set forth in claim 14, the plurality of electronic processing elements being further configured to—
responsive to determining that the electronic record does not exist in the database, allow the requesting user to create the electronic record for the particular contact.

18. (canceled)

19. The system as set forth in claim 14, the electronic processing element being further configured to responsive to determining that the electronic record does exist in the database and the requesting user is the user of record, allow the requesting user to access the electronic record.

20. (canceled)

21. The computer-implemented method as set forth in claim 27, further including presenting certain limited information from each of the two or more electronic records to the requesting user.

22.-25. (canceled)

26. The computer-implemented method as set forth in claim 1, further comprising:
allowing an additional electronic device access to the electronic record in the server network at a later time.

27. The computer-implemented method as set forth in claim 1, further including: responsive to determining that two or more electronic records in the database of electronic records match the electronic request, allowing the requesting user to select the electronic record from the two or more electronic records.

28. The system as set forth in claim 14, the electronic processing element being further configured to: responsive to determining that two or more electronic records in the database of electronic records match the electronic request, allow the requesting user to select the electronic record from the two or more electronic records.

29. A computer-implemented method for improving the functioning of a computer for managing access to an electronic record in a database of electronic records, the electronic record containing a set of information about a particular contact, the computer-implemented method comprising the following performed by an electronic communications element and a plurality of electronic processing elements distributed across a number of geographic locations and electrically connected via a server network:
receiving, by the electronic communications element from a user interface of an electronic device via the server network, an electronic request from a requesting user who is different from the contact for access to the electronic record;
searching, by at least one of the plurality of electronic processing elements using an electronic search engine based upon an identifier in the electronic request, the database for the electronic record, the database located remotely from the electronic device in the server network;
responsive to determining, by the at least one of the plurality of electronic processing elements, that the electronic record does not exist in the database, allowing, by the at least one of the plurality of electronic processing elements via the electronic communications element, the requesting user to create the electronic record for the particular contact; and
responsive to determining, by the at least one of the plurality of electronic processing elements, that the electronic record does exist in the database and the electronic record is assigned a type which is associated with a user of record who is not the requesting user,
requiring, by the at least one of the plurality of electronic processing elements via the user interface of the electronic device, the requesting user to enter an identifying piece of information about the contact,
matching, by the at least one of the plurality of electronic processing elements, the entered identifying piece of information with a correct identifying piece of information from among the set of information stored in the electronic record, and
responsive to determining that the entered identifying piece of information matches the correct identifying piece of information, transmitting, using the electronic communications element, the electronic record to the requesting user with a time limit during which the electronic device is allowed access to the electronic record in the server network, wherein the time limit is eliminated based upon determining that the electronic record is assigned a type that has no user of record assigned thereto.

30. A system for managing access to an electronic record in a database of electronic records, the electronic record containing a set of information about a particular contact, the system comprising:
an electronic communications element configured to receive an electronic request from a requesting user who is different from the contact via a server network from a user interface of an electronic device for access to the electronic record; and
a plurality of electronic processing elements configured to
search the database of electronic records located remotely from the electronic device in the server network for the electronic record with an electronic search engine based upon an identifier in the electronic request;
responsive to determining that the electronic record does not exist in the database, allow the requesting user to create the electronic record for the particular contact via the electronic communications element, and
responsive to determining that the electronic record does exist in the database and the electronic record is assigned a type which is associated with a user of record who is not the requesting user,
require via the user interface of the electronic device the requesting user to enter an identifying piece of information about the contact,
match the entered identifying piece of information with a correct identifying piece of information from among the set of information stored in the electronic record, and
responsive to determining that the entered identifying piece of information matches the correct identifying piece of information, transmit the electronic record to the requesting user using the electronic communications element with a time limit during which the electronic device is allowed access to the electronic record in the server network, wherein the time limit is eliminated based upon determining that the electronic record is assigned a type that has no user of record assigned thereto.
